(19) United States
(12) Patent Application Publication
(10) Pub. No.: US 2022/0116804 A1
(43) Pub. Date: Apr. 14, 2022

(54) METHOD AND SYSTEM FOR WIRELESS SENSING ANALYSIS WITH A NON-COOPERATIVE RECIPIENT DEVICE

(71) Applicants: Ali ABEDI, Waterloo (CA); Omid SALEHI-ABARI, Los Angeles, CA (US)

(72) Inventors: Ali ABEDI, Waterloo (CA); Omid SALEHI-ABARI, Los Angeles, CA (US)

(21) Appl. No.: 17/494,295

(22) Filed: Oct. 5, 2021

Related U.S. Application Data
(60) Provisional application No. 63/204,480, filed on Oct. 8, 2020.

(51) Int. Cl. H04W 24/08; H04W 12/08

(52) U.S. Cl. CPC H04W 24/08; H04W 84/12; H04W 12/08

(57) ABSTRACT

There is provided a system and method for performing non-cooperative sensing analysis with a recipient device over a wireless communication standard. The non-cooperative sensing analysis performed without requiring permitted access to communicate wirelessly with the recipient device. The method including: generating an inspection packet, the inspection packet including a mock media access control address (MAC) address as a sender address and a MAC address associated with the recipient device as a receiver address; transmitting the inspection packet to the recipient device using the wireless communication standard; receiving a response packet from the recipient device, the response packet including the mock MAC address as a receiver address; generating a derivative metric from the response packet; and outputting the derivative metric.

### TECHNICAL FIELD

The following relates generally to wireless communication, and more specifically, to a method and system for performing sensing analysis with a non-cooperative recipient device over a wireless communication standard.

### BACKGROUND

In many communication protocols, such as in the Wi-Fi protocol, when a device sends a frame to another device, the receiving device sends an acknowledgement back to the transmitter. This mechanism is deployed to deal with error prone wireless channels and to handle retransmissions in the physical and MAC layer. In particular, upon receiving a frame, the receiver calculates the cyclic redundancy check (CRC) of the frame to detect possible errors. If the frame passes CRC, then the receiver sends an Acknowledgment (ACK) to the transmitter to notify the correct reception of the frame.

### SUMMARY

In an aspect, there is provided a computer-implemented method for performing sensing analysis with a non-cooperative recipient device over a wireless communication standard, the sensing analysis performed while not having permitted access to communicate wirelessly with the recipient device, the method comprising: generating an inspection packet to generate a response from the recipient device, the inspection packet comprising an address associated with the recipient device as a receiver address and a generated address as a sender address, the inspection packet lacking encryption that is expected by the protected access wireless communication standard to access the recipient device; transmitting the inspection packet to the recipient device using the wireless communication standard; receiving a response packet from the recipient device, the response packet comprising the generated address as a receiver address; generating a derivative metric from the response packet; and outputting the derivative metric.

In a particular case of the method, the generated address is a mock or spoof address.

In another case of the method, generating the inspection packet, transmitting the inspection packet, and receiving the response packet are performed repeatedly to generate the derivative metric.

In yet another case of the method, generating the derivate metric comprises determining a Received Signal Strength Indicator (RSSI).

In yet another case of the method, generating the derivate metric comprises determining Channel State Information (CSI).

In yet another case of the method, generating the inspection packet, transmitting the inspection packet, and receiving the response packet are performed repeatedly to generate the derivative metric, and wherein the CSI information is used to determine proximity of a user to the recipient device.

In yet another case of the method, generating the derivate metric comprises determining Time of Flight (ToF) information.

In yet another case of the method, the TOF information is used to obtain a distance to the recipient device.

In yet another case of the method, the wireless communication comprises communication over a WiFi network.

In yet another case of the method, the wireless communication comprises communication using Bluetooth, zigbee, or z-wave.

In another aspect, there is provided a system for performing sensing analysis with a non-cooperative recipient device over a wireless communication standard, the sensing analysis performed while not having permitted access to communicate wirelessly with the recipient device, the system comprising one or more processors in communication with a data storage, the one or more processors configurable to execute: a packet module to generate an inspection packet to generate a response from the recipient device, the inspection packet comprising an address associated with the recipient device as a receiver address and a generated address as a sender address, the inspection packet lacking encryption that is expected by the protected access wireless communication standard to access the recipient device, and to transmit the inspection packet to the recipient device using the wireless communication standard; a response module to receive a response packet from the recipient device, the response packet comprising the generated address as a receiver address; an extraction module to generate a derivative metric from the response packet; and an output module to output the derivative metric.

In a particular case of the system, the generated address is a mock or spoof address.

In another case of the system, generating the inspection packet, transmitting the inspection packet, and receiving the response packet are performed repeatedly to generate the derivative metric.

In yet another case of the system, generating the derivate metric comprises determining a Received Signal Strength Indicator (RSSI).

In yet another case of the system, generating the derivate metric comprises determining Channel State Information (CSI).

In yet another case of the system, generating the inspection packet, transmitting the inspection packet, and receiving the response packet are performed repeatedly to generate the derivative metric, and wherein the CSI information is used to determine proximity of a user to the recipient device.

In yet another case of the system, generating the derivate metric comprises determining Time of Flight (ToF) information.

In yet another case of the system, the TOF information is used to obtain a distance to the recipient device.

In yet another case of the system, the wireless communication comprises communication over a WiFi network.

In yet another case of the system, the wireless communication comprises communication using Bluetooth, zigbee, or z-wave.

These and other aspects are contemplated and described herein. It will be appreciated that the foregoing summary sets out representative aspects of systems and methods for animated lip synchronization to assist skilled readers in understanding the following detailed description.

### BRIEF DESCRIPTION OF THE DRAWINGS

A greater understanding of the embodiments will be had with reference to the Figures, in which:

FIG. 1 is a block diagram of a system for performing non-cooperative wireless communication sensing analysis, in accordance with an embodiment;

FIG. 2 is a flow diagram of a method for performing non-cooperative wireless communication sensing analysis, in accordance with an embodiment;

FIG. 3 is a diagram showing an example of a querier and recipient arrangement in accordance with the system of FIG. 1;

FIG. 4 shows real traffic between a querier device and a recipient device captured using a packet sniffer in an example experiment;

FIG. 5 shows network traffic in the example experiments of FIG. 4 illustrating deauthentication frames; and

FIG. 6 shows a chart of a CSI amplitude of a signal received from a recipient device for further example experiments.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to wireless communication, and more specifically, to a method and system for non-cooperative wireless communication sensing analysis.

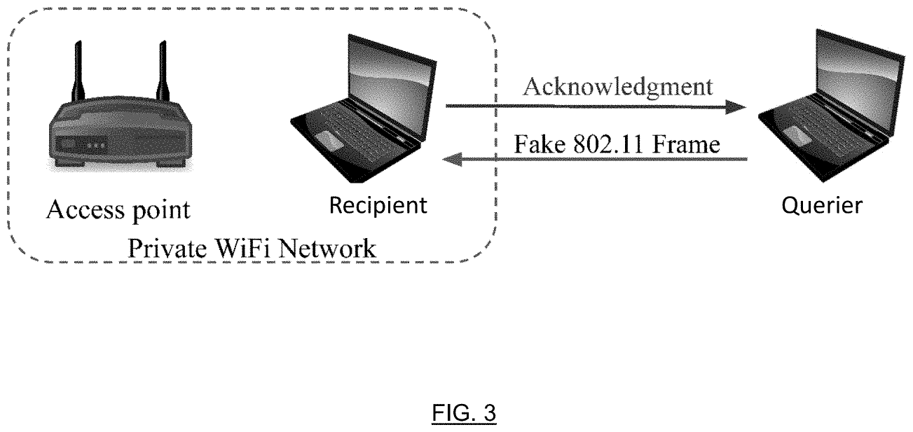

Since many communication networks use security protocols (such as Wi-Fi Protected Access 2 (WPA2)) to prevent unauthorized devices from joining, many would assume that a network-connected device only acknowledges frames received from the associated access point or other devices in the same network. However, many communication protocols acknowledge any frame they receive as long as the destination address matches their MAC address. In the Wi-Fi protocol, a physical layer acknowledges all frames, even those without any valid payload; although higher layers eventually discard the inspection packet. Consider a scenario where a client device is connected to an access point, as shown in the example diagram of FIG. 3. This is a private network secured by protocols such as WPA2. It has been determined that if a ‘querier’ sends an ‘inspection’ packet with an unencrypted 802.11 frame to the client device (labeled as ‘recipient’), the client device sends back an acknowledgment. The present inventors have determined that this response behavior in wireless communication protocols advantageously provides opportunities for sensing analysis. Advantageously, this sensing analysis can be implemented on only one device (the querier), instead of requiring modified behaviour on the other device (the recipient) due to the other device merely performing standard protocol behaviour.

The present inventors have run an example experiment where two Wi-Fi devices act as the recipient and the querier. For the recipient, a tablet was used, and for the querier, a USB Wi-Fi dongle that has a Realtek™ RTL8812AU 802.11ac chipset was used. As described herein, the querier uses this device to send inspection frames to the recipient device. Arbitrary frames were generated with custom data in the header fields; where the only valid information in the frame is the destination MAC address (i.e., the recipient's MAC address). The transmitter MAC address is set to a “mock” MAC address (aa:bb:bb:bb:bb:bb), and the frame has no payload (i.e., null frame) and is not encrypted.

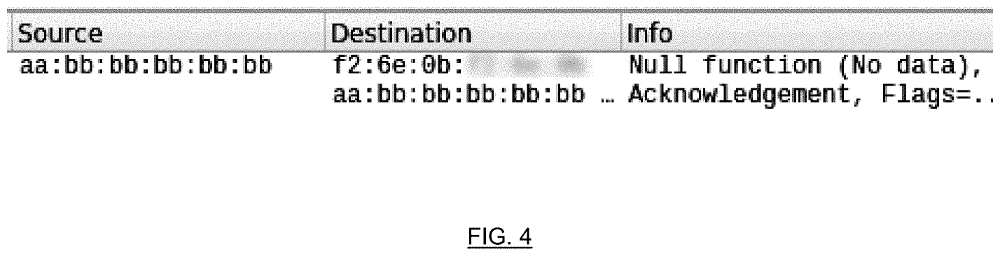

FIG. 4 shows real traffic between the querier and the recipient device captured using a Wireshark™ packet sniffer in the example experiment. As can be seen, when the querier sends an inspection frame to the recipient, the recipient sends back an ACK to the mock MAC address (aa:bb:bb:bb:bb:bb). This example experiment confirms that Wi-Fi devices acknowledge any frame without checking its validity. This behavior was determined to exist on a number of other Wi-Fi devices (for example, laptops, smart thermostats, tablets, smartphones, and access points, and the like) and under other wireless protocols/standards (for example, Bluetooth™, Zigbee™, z-Wave™, and others).

In wireless networks, the physical layer is generally responsible for transmitting and receiving Wi-Fi frames over a wireless channel. When the physical layer receives a frame, it checks the correctness of the frame using error checking mechanisms and transmits an acknowledgment (ACK) if the frame has no error. However, checking the validity of the content of a frame is performed by the media access control (MAC) and higher layers. Since the physical layer does not coordinate with higher layers about sending ACKs, this automated behaviour can be used for sensing analysis in accordance with the present embodiments.

In some cases, it has been observed that when some access points receive inspection frames, as described, these devices send “deauthentication” frames to the querier; essentially requesting it to leave the network even though the querier may not have been ever part of the network. In this way, some access points detect the querier as a “malfunctioning” device and send deauthentication frames accordingly. However, even if they are receiving inspection frames from a supposed “malfunctioning” device, these devices still acknowledge the inspection frames.

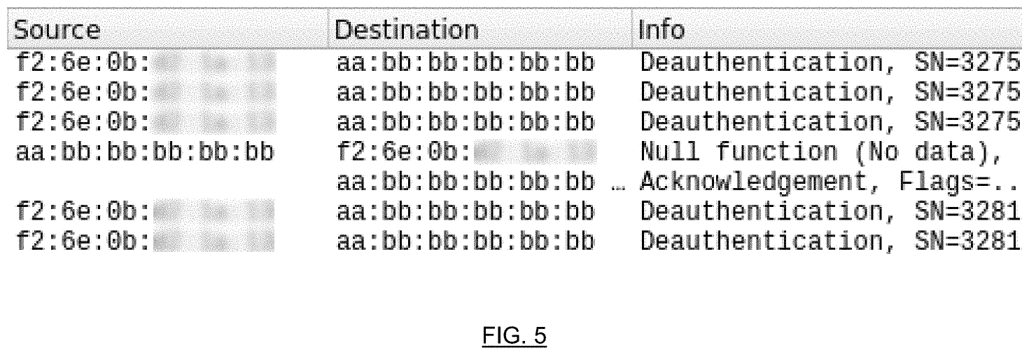

Another example of network traffic in the example experiment is shown in FIG. 5. As can be seen, although the access point has already sent three deauthentication frames to the querier, it still acknowledges the querier's inspection frame. In this way, sending ACK frames occurs automatically in the physical layer without any communication with higher layers.

Generally, sensing analysis, such as Wi-Fi sensing to determine gesture recognition, occupancy detection, and the like, has received significant interest for its many practical applications. Typical Wi-Fi sensing systems require two devices to operate, one for transmitting Wi-Fi packets and another one for receiving Wi-Fi signals. By analyzing the change in the received signal, these systems can sense, for example, different movements in the environment. However, for these systems to effectively work, they require the recipient device to be approximately in the line-of-sight between two Wi-Fi devices. Therefore, in order to perform Wi-Fi sensing for a large area, such as an entire house, these systems require multiple devices to cover the whole area; which is generally not feasible because typical Wi-Fi sensing techniques require 100 to 1000 packets per seconds to operate. This rate is much greater than natural traffic for many Wi-Fi devices. Hence, typical Wi-Fi sensing systems require modification to Wi-Fi devices to force them to transmit packet frequently. Changing this behaviour on access points and some devices, like Internet-of-Things sensors and smart TVs, might be difficult or practically infeasible.

Generally, Wi-Fi sensing technologies gather various types of information from the surrounding environment by exploiting existing Wi-Fi signals. The human body changes wireless signals; therefore, by monitoring and learning these changes, Wi-Fi sensing can enable applications such as occupancy/motion detection, gesture recognition, or even breathing rate estimation. Non-cooperative Wi-Fi sensing, as in the present embodiments, acquires a wireless signal from a wireless device without requiring voluntary cooperation from such device. As used herein, the system/device that wants to obtain the signal is called the querier and the device that the signal is obtained from is called the recipient or the target device.

While the present embodiments generally refer to the Wi-Fi protocol/standard for implementing the non-cooperative wireless communication sensing analysis, it is understood that any suitable wireless protocol/standard can be used; for example, Bluetooth™, Zigbee™, z-Wave™, or the like.

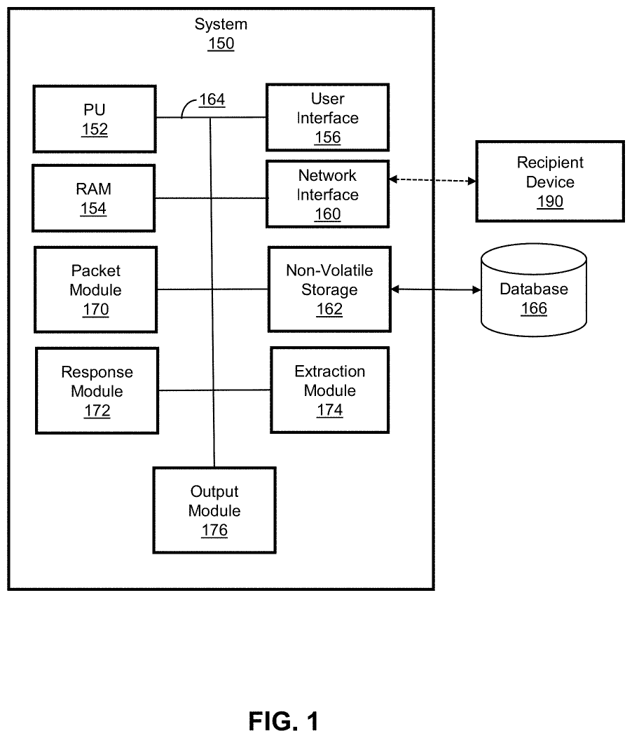

Turning to FIG. 1, a system 150 for performing non-cooperative wireless communication sensing analysis is shown, according to an embodiment. In this embodiment, the system 150 is run on a local computing device (for example, a wireless microcontroller). In further embodiments, the system 150 can be run on any other computing device; for example, a server, a dedicated piece of hardware, a laptop computer, a smartphone, a tablet, purpose-built hardware, a wireless access point, or the like. In some embodiments, the components of the system 150 are stored by and executed on a single computing device. In other embodiments, the components of the system 150 are distributed among two or more computer systems that may be locally or remotely distributed; for example, using cloud-computing resources.

FIG. 1 shows various physical and logical components of an embodiment of the system 150. As shown, the system 150 can have a number of physical and logical components, including a processing unit (“PU”) 152 (comprising one or more processors), random access memory (“RAM”) 154, a user interface 156, a network interface 160, non-volatile storage 162, and a local bus 164 enabling the PU 152 to communicate with the other components. The PU 152 can execute an operating system, and various modules, or can execute the various modules directly. RAM 154 provides relatively responsive volatile storage to the PU 152. The user interface 156 enables an administrator or user to provide input via an input device, for example a mouse or a touchscreen. The user interface 156 also outputs information to output devices; for example, a display. The network interface 160 is used to send communication packets to a recipient device 190 over a wireless network and to receive packets from the recipient device 190 over the wireless network.

Non-volatile storage 162 stores the operating system and/or instructions for executing the modules, as well as any data used by these services. In some cases, additional stored data can be stored in a database 166. During operation of the system 150, the instructions and the related data may be retrieved from the non-volatile storage 162 and placed in RAM 154 to facilitate execution.

In an embodiment, the system 150 further includes a number of functional modules to be executed on the PU 152; for example, a packet module 170, a response module 172, an extraction module 174, and an output module 176. In further cases, the functions of the modules can be combined or executed by other modules.

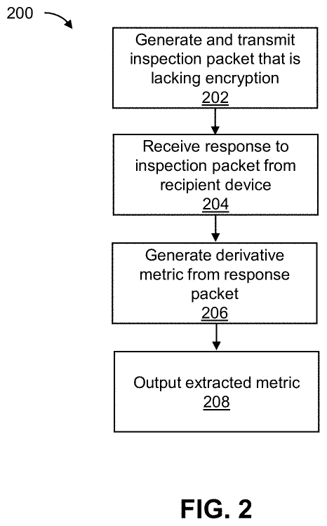

Turning to FIG. 2, a flowchart of a method 200 for performing non-cooperative wireless communication sensing analysis is shown, according to an embodiment. It is understood that generally the system 150 performs the actions of the querier.

At block 202, the packet module 170 generates an inspection packet to trigger a response from the recipient device 190 and uses the network interface 160 to transmit the inspection packet to the recipient device 190. The packet module 170 generates the inspection packet lacking encryption (such as with improper encryption credentials); particularly, the encryption that would be expected by the protected access wireless communication standard (e.g., WPA2) in order to access the recipient device 190. In this way, the inspection packet is intended to receive a response from the physical layer at the recipient device 190 but get discarded by higher layers.

In some cases, the sender address (which can be referred to as S-ADDR) of the inspection packet is generated by the packet module 170 and can be a mock MAC address designed to appear like a valid MAC address, or can be purely an invalid address. The mock MAC address can be randomly generated or predetermined to be not of an applicable device on the network. In other cases, the sender address of the inspection packet can be the actual MAC address of the system 150. In further cases, the sender address can be a spoof MAC address to feign that the inspection packet is coming from a particular device having that particular MAC address. The receiver address of the inspection packet is the MAC address of the recipient device 190.

At block 204, the response module 172 receives a response from the recipient device 190 to the inspection packet. In an 802.11 Wi-Fi network, the type of the responses can be one of the following:
If the inspection packet is a data packet, the response is an acknowledgement (ACK).
If the inspection packet is a block ACK request, the response is a block ACK.
If the inspection packet is a Request To Send (RTS), the response is a Clear To Send (CTS).

The response is sent automatically by the Wi-Fi physical/MAC layer of the recipient device 190. As a result, the recipient device 190 does not need to install any software or undertake any special protocol in order to send these responses.

The response module 172 can be placed in a “monitor mode” and receive any packet; including the response that is transmitted on a given frequency. Since the recipient device 190 responds to the inspection packet, the receiver address of the response is S-ADDR. The response module 172 can use this information to filter incoming responses and distinguish them from other packets.

At block 206, the extraction module 174 generate a derivative metric from the response packet. In some cases, the derivative metric can be generated after repeating block 202 and 204 by sending multiple inspection packets and receiving the respective response packets. Examples of derivative metrics that can be generated from response packets are Received Signal Strength Indicator (RSSI), Channel State Information (CSI), and Time of Flight (ToF) information.

RSSI and CSI can be used for inferring various types of information in Wi-Fi sensing applications. Both RSSI and CSI data are generally added to each received packet as metadata and the extraction module 174 can extract this information from the response packet.

RSSI determines the strength of the received signal as determined by the Wi-Fi hardware for each received packet. The hardware measures the signal strength as a part of the automatic gain control (AGC) to know how much it needs to amplify a received signal. The extraction module 174 can use this determined signal strength of the response packets to infer properties of the recipient device 190, such as proximity.

CSI is measured as part of a preamble of Wi-Fi packets. The preamble contains predetermined bits of information. Since the system 150 knows what data was originally transmitted, the extraction module 174 can estimate the wireless channel between the sender and receiver. The CSI generally contains an amplitude and a phase of the channel for each OFDM subcarrier.

The extraction module 174 can generate ToF data from the received packet by recording the time at which the inspection packet is transmitted and the time at which the corresponding response is received by the response module 172. This difference between these two times (ΔT) includes the round-trip time to send the inspection packet and receive the response packet and the time the recipient device 190 spends on processing the inspection packet and preparing the response packet. In the example of the 802.11 standard, The processing time at the recipient device 190 is called Short InterFrame Spacing (SIFS) and defined by the IEEE 802.11 standard to be 10 and 16 microseconds in the 2.4 GHz and 5 GHz spectrums, respectively. Consequently, the extraction module 174 can subtract the processing time from ΔT and divide it by 2 to obtain ToF data between the system 150 and the recipient device 190. Since electromagnetic signals travel substantially at the speed of light (in a vacuum and close to the speed of light in air), the recipient device 190 can also divide ToF by the speed of light to obtain the distance to the target device. In some cases, the extraction module 174 can store successive distance determinations to track movement of the recipient device 190 by comparing successive distance measurements. In further cases, multiple systems 150 or just multiple network interfaces 160 can be used to receive response packets from multiple locations. In this way, distances to the recipient device 190 can be determined from multiple vantage points, allowing localization and tracking of movement of the recipient device 190 in more than one dimension.

In further cases, the extraction module 174 can generate other data from the received response, such as data determined over successive responses over a defined period of time. In such techniques, changes of the signal over time can be used to perform sensing. After obtaining sufficient data over time, the extraction module 174 performs wireless communication sensing analysis. Depending on the type of sensing, all or a subset of the collected data is used to infer the intended information, for example, by inspecting the signal over time and determining if the intended information is present.

At block 208, the output module 176 outputs the generated derivative metric, for example, to be stored on the database 166, to be displayed on the user interface 156, or communicated to another device over the network interface 160.

The present inventors conducted example experiments to verify advantages of the present embodiments. In such experiments, the recipient device 190, a Microsoft™ Surface Pro™ tablet, was connected to a Wi-Fi access point. The system 150 was placed in a different room. The system 150 was implemented on an ESP32 Wi-Fi module. The system 150 had no permitted access to the wireless network of the recipient device 190 nor did it have the secret key to gain access to this network. The system 150 sent 150 inspection 802.11 frames per second (i.e., null frames with no encryption) to the recipient device 190, and measured the CSI of acknowledgement frames received from the recipient device 190.

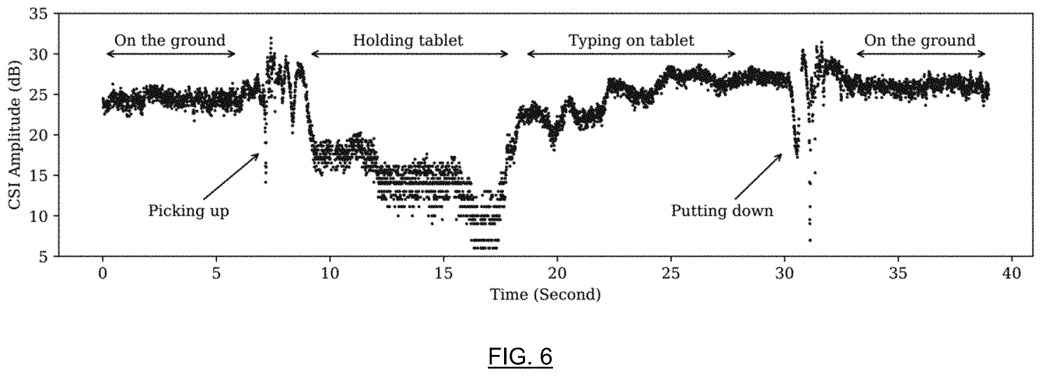

For the example experiments, FIG. 6 shows the CSI amplitude of the signal received from the recipient device 190 for Orthogonal Frequency Division Multiplexing (OFDM) subcarrier 17. Most other subcarriers had similar patterns. As illustrated, when the recipient device 190 is on the ground, the signal amplitude is very stable. However, as soon as a user approaches the recipient device 190 and picks it up, the CSI amplitude experiences large fluctuations. Next, the user holds the recipient device 190 for about 10 seconds and then starts typing for about 10 seconds. It is very clear that the patterns of just holding the tablet and typing are very distinct. This behavior can be determined by comparing the received signal against a ground truth signal that was previously acquired while such behaviors were being performed. This example experiment was repeated multiple times and similar patterns were observed. Accordingly, the system 150 can use the response packets of method 200 to reveal information about the recipient device 190 and its surroundings, such as proximity of the user, without any voluntary cooperation from the recipient device 190, and without any permitted access to the wireless environment of the recipient device 190.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A computer-implemented method for performing sensing analysis with a non-cooperative recipient device over a protected access wireless communication standard, the method comprising:
generating an inspection packet to generate a response from the recipient device, the inspection packet comprising an address associated with the recipient device as a receiver address and a generated address as a sender address, the inspection packet lacking encryption that is expected by the protected access wireless communication standard to access the recipient device;
transmitting the inspection packet to the recipient device using the wireless communication standard;
receiving a response packet from the recipient device, the response packet comprising the generated address as a receiver address;
generating a derivative metric from the response packet; and
outputting the derivative metric.

2. The method of claim 1, wherein the generated address is a mock or spoof address.

3. The method of claim 1, wherein generating the inspection packet, transmitting the inspection packet, and receiving the response packet are performed repeatedly to generate the derivative metric.

4. The method of claim 1, wherein generating the derivate metric comprises determining a Received Signal Strength Indicator (RSSI).

5. The method of claim 1, wherein generating the derivate metric comprises determining Channel State Information (CSI).

6. The method of claim 5, wherein generating the inspection packet, transmitting the inspection packet, and receiving the response packet are performed repeatedly to generate the derivative metric, and wherein the CSI information is used to determine proximity of a user to the recipient device.

7. The method of claim 1, wherein generating the derivate metric comprises determining Time of Flight (ToF) information.

8. The method of claim 7, wherein the TOF information is used to obtain a distance to the recipient device.

9. The method of claim 1, wherein the wireless communication comprises communication over a WiFi network.

10. The method of claim 1, wherein the wireless communication comprises communication using Bluetooth, zigbee, or z-wave.

11. A system performing sensing analysis with a non-cooperative recipient device over a wireless communication standard, the sensing analysis performed while not having permitted access to communicate wirelessly with the recipient device, the system comprising one or more processors in communication with a data storage, the one or more processors configurable to execute:
a packet module to generate an inspection packet to generate a response from the recipient device, the inspection packet comprising an address associated with the recipient device as a receiver address and a generated address as a sender address, the inspection packet lacking encryption that is expected by the protected access wireless communication standard to access the recipient device, and to transmit the inspection packet to the recipient device using the wireless communication standard;
a response module to receive a response packet from the recipient device, the response packet comprising the generated address as a receiver address;
an extraction module to generate a derivative metric from the response packet; and
an output module to output the derivative metric.

12. The system of claim 11, wherein the generated address is a mock or spoof address.

13. The system of claim 11, wherein generating the inspection packet, transmitting the inspection packet, and receiving the response packet are performed repeatedly to generate the derivative metric.

14. The system of claim 11, wherein generating the derivate metric comprises determining a Received Signal Strength Indicator (RSSI).

15. The system of claim 11, wherein generating the derivate metric comprises determining Channel State Information (CSI).

16. The system of claim 15, wherein generating the inspection packet, transmitting the inspection packet, and receiving the response packet are performed repeatedly to generate the derivative metric, and wherein the CSI information is used to determine proximity of a user to the recipient device.

17. The system of claim 11, wherein generating the derivate metric comprises determining Time of Flight (ToF) information.

18. The system of claim 17, wherein the TOF information is used to obtain a distance to the recipient device.

19. The system of claim 11, wherein the wireless communication comprises communication over a WiFi network.

20. The system of claim 11, wherein the wireless communication comprises communication using Bluetooth, zigbee, or z-wave.
